(19) United States
(12) Patent Application Publication
(10) Pub. No.: US 2016/0113021 A1
(43) Pub. Date: Apr. 21, 2016

(54) METHOD AND SYSTEM FOR INTERFERENCE MANAGEMENT FOR DEVICE-TO-DEVICE COMMUNICATIONS

(71) Applicants: Yifei YUAN, Morristown, NJ (US); ZTE (USA) INC., Richardson, TX (US)

(72) Inventor: Yifei YUAN, Morristown, NJ (US)

(21) Appl. No.: 14/889,743

(22) PCT Filed: Apr. 16, 2014
(86) PCT No.: PCT/US2014/034324

§ 371 Date: Nov. 6, 2015

Related U.S. Application Data
(60) Provisional application No. 61/821,972, filed on May 10, 2013.

(51) Int. Cl. H04W 72/08; H04W 72/04; H04W 76/02

(52) U.S. Cl. CPC H04W 72/082; H04W 76/023; H04W 72/0406

(57) ABSTRACT

Reusing resources among different D2D pairs may result in significant inter-pair interference. The scheme outlined in this invention involves the network configuration of UEs to transmit sequences that bear the physical ID information of the D2D UEs. Such sequence is broadcast to nearby D2D UEs who would detect and report the ID to the network. The network can identify the potential interfering UEs and assign the appropriate resources among D2D pairs.

### FIELD OF THE INVENTION

The present invention relates to a method and system for inter-UE (User Equipment) channel quality measurement with the purpose of inter-pair interference management. Specifically, the invention relates to efficiently reporting the channel strength related information between potentially interfered UEs.

### BACKGROUND OF THE INVENTION

Device-to-device (D2D) communications, in contrast to the traditional cellular communications, allow direct data transfer between UEs in proximity, without going through the network. Not only that the communication latency can be reduced, D2D can also improve the data throughput of the overall systems and save the UE's transmit power, when peer UEs (sharing the same interest) are close by.

Resource reuse is a very important aspect of D2D which can be considered as another way of cell-splitting. The relatively low height of UE antennas results in smaller coverage of each UE in general, therefore justifying the resource reuse among different D2D pairs as long as they are not adjacent to each other. Resource reuse can significantly increase the total throughput within a cell, especially when there are a large number of UEs engaged in D2D communications.

Although the coverage of UE is generally small, it is not guaranteed that different D2D pairs can always reuse the same resource. A fundamental issue with D2D communications is how to manage the myriad links between UEs. In cellular communications, one only needs to measure the channels between the UE and a few base stations (serving and neighbors), while the number of inter-UE channels can be huge, even when only same cell UEs are considered.

Exhaustive enumerating all the UE-UE links is obviously not efficient as the coverage of a UE is much smaller than a cell size. Hence, it is crucial that UE-UE link quality can be fed back efficiently to only capture the potentially dominant interfering pairs, so that resource reuse would be performed between the “far apart” UE pairs.

### SUMMARY OF THE INVENTION

In accordance with one aspect, the present invention comprises a method of transmission of sequences that contain the ID information in a broadcast manner. Any D2D UE is allowed to detect the sequences, although for many UEs, the received signals of the sequences may be too weak for reliable detection.

According to the present invention, the ID information is purely a physical identity that does not carry any upper layer information. Such ID is only used to differentiate D2D UEs close by. The IDs are managed and configured by the network. More specifically, the detected IDs consist of those UEs whose D2D communications would interfere with the D2D communication of the UE that carries out the detection.

According to the present invention, the UE would transmit the sequence with certain power known to the potential receivers. The transmit power setting for this purpose can be done by higher layer signaling.

According to the present invention, the frequency and time resources for the sequence transmission are configured by the network. A D2D UE can transmit or detect the sequence in active mode or idle mode.

According to the present invention, the D2D UEs that detect the sequences would report the ID to the network.

In another aspect, the invention comprises a system where a D2D UE transmits a sequence in a broadcast manner to other D2D UEs. The sequence contains pure physical ID information of the transmitting UE. The D2D UEs that detect the sequence would report the ID to the network. The network uses that ID information to manage the resource reuse between D2D pairs.

### BRIEF DESCRIPTION OF THE FIGURES

Having thus described the invention in general terms, reference is now made to the accompanying drawings, which are not necessarily drawn to scale. The accompanying drawings are included to provide a further understanding of the invention, and are incorporated in and constitute a part of this specification. The drawings illustrate disclosed embodiments and/or aspects and, together with the description, serve to explain the principles of the invention, the scope of which is determined by the claims.

FIG. 1 shows an example of potential interference caused by reusing the same resources among different D2D pairs that are close by. FIG. 2 shows an example of interference management procedure based on D2D UE transmitting sequences bearing physical ID information.

### DETAILED DESCRIPTION OF THE INVENTION

The present inventions now will be described more fully hereinafter with reference to the accompanying drawings, as needed, in which some examples of the embodiments of the inventions are shown. It is to be understood that the figures and descriptions provided herein may have been simplified to illustrate elements that are relevant for a clear understanding of the present invention, while eliminating, for the purpose of clarity, other elements found in typical D2D communication systems and methods. Those of ordinary skill in the art may recognize that other elements and/or steps may be desirable and/or necessary to implement the devices, systems, and methods described herein. However, because such elements and steps are well known in the art, and because they do not facilitate a better understanding of the present invention, a discussion of such elements and steps may not be provided herein. The present disclosure is deemed to inherently include all such elements, variations, and modifications to the disclosed elements and methods that would he known to those of ordinary skill in the pertinent art. Indeed, these disclosures may be embodied in many different forms and should not be construed as limited to the embodiments set forth therein; rather, these embodiments are provided by way of example so that this disclosure will satisfy applicable legal requirements. Like numbers refer to like elements throughout.

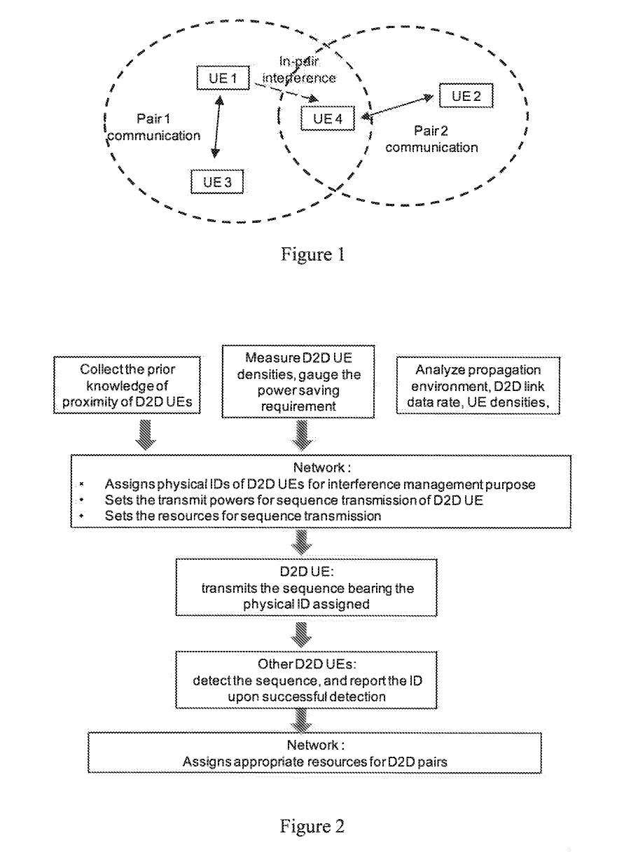

The invention considers a very fundamental issue of D2D communications: how would the network know the UE-UE link strengths in an efficient manner. As the number of D2D UEs within a cell can be quite large, the total number UE-UE links would be myriad. However, due to the antenna height of UE and less favorable propagation environment compared to base station to UE links, the realistic range for UE-UE communications tends to be small. Therefore, excluding the D2D UEs of the same pair, a D2D UE, for example, UE4, may only have a few dominant interfering UEs, for example, UE2, if the resources of Pair 1 communication and Pair 2 communication, are reused, as illustrated FIG. 1. UEs belonging to different D2D pairs may not know each other. In order to expose all the potential interferers, the transmitting UE should be visible to all the D2D UEs nearby. Such generic visibility requires that the transmitting UE should carry a physical ID information whose purpose is only to differentiate the physical UEs, and not to reveal any upper layer information of the UE which may result in security risks. The physical ID is encapsulated into a sequence, broadcast to all D2D UEs. Due to the limited coverage of a D2D UE, only nearby D2D UEs may detect the sequence.

The corresponding interference management is illustrated in an example shown in FIG. 2. First, the network collects the prior knowledge of the geographical closeness of D2D UEs, either through the UE positioning techniques, or previous measurement of beacons. The network also needs to consider the D2D UE densities and power saving requirement, together with the typical D2D communication data rate and propagation environment. Based on these input, the network then assigns physical IDs of D2D UEs for interference management purpose. It also sets transmit powers and time-frequency resources for sequence transmission of D2D UEs. Such configuration can be through higher layer signaling that may be updated in a semi-static manner. In the next step, D2D UE transmits the sequence bearing the physical ID assigned. The transmission is effectively a broadcast that can be heard by any D2D UEs nearby. Upon successful detection, the receiving UEs report to the network the IDs they identified. In the end, the network collects those detected IDs and the IDs of UEs that report the detection, and do appropriate resource assignment for D2D pairs.

Many modifications and alterations of the new methods and systems described herein may be employed by those skilled in the art without departing from the spirit and scope of the invention which is limited only by the claims. Although the invention has been described and illustrated in exemplary forms with a certain degree of particularity, it is noted that the description and illustrations have been made by way of example only. Specific terms are used in this application in a generic and descriptive sense only and not for purposes of limitation. Numerous changes in the details of construction and combination and arrangement of parts and steps may be made. Accordingly, such changes are intended to be included in the invention, the scope of which is defined by the claims.

1. A method for D2D communication interference management comprises transmitting sequences that contain ID information in a broadcast manner, reporting channel strength related information between potentially interfered UEs, and assigning appropriate resources for D2D pairs.

2. The method of claim 1, where the ID information is purely a physical identity that does not carry any upper layer information.

3. The method of claim 2, where the ID information is only used to differentiate D2D UEs close by.

4. The method of claim 1, where the ID information are managed and configured by a network.

5. The method of claim 1, where the UE transmits the sequence with certain power known to potential receivers.

6. The method of claim 5, where the transmitted power setting is performed by a higher layer signaling.

7. The method of claim 4, where the frequency and time resources for the sequence transmission are configured by the network.

8. The method of 2, where the D2D UEs transmit or detect the sequence in active mode or idle mode.

9. The method of claim 8, where the D2D UEs that detect the sequences report the ID information to the network.

10. A system for D2D communication interference management comprises means for transmitting sequences that contain ID information in a broadcast manner. reporting channel strength related information between potentially interfered UEs, and assigning appropriate resources for D2D pairs.

11. The system of claim 10, where the ID information is purely a physical identity that does not carry any upper layer information.

12. The system of claim 11, where the ID information is only used to differentiate D2D UEs close by.

13. The system of claim 10, where the ID information are managed and configured by a network.

14. The system of claim 10, where the UE transmits the sequence with certain power known to potential receivers.

15. The system of claim 14, where the transmitted power setting is performed by a higher layer signaling.

16. The system of claim 13, where the frequency and time resources for the sequence transmission are configured by the network.

17. The system of claim 11, where the D2D UEs transmit or detect the sequence in active mode or idle mode.

18. The system of claim 17, where the D2D UEs that detect the sequences report the ID information to the network.
